(19) United States
(12) Patent Application Publication
(10) Pub. No.: US 2026/0164475 A1
(43) Pub. Date: Jun. 11, 2026

(54) SYSTEMS AND METHODS FOR PERFORMING SIDELINK CHANNEL OCCUPANCY TIME (COT) SHARING ON UNLICENSED CARRIER

(71) Applicant: ZTE Corporation, Shenzhen (CN)

(72) Inventors: Wei LUO, Shenzhen (CN); Weiqiang DU, Shenzhen (CN); Lin CHEN, Shenzhen (CN)

(73) Assignee: ZTE Corporation, Shenzhen (CN)

(21) Appl. No.: 19/183,425

(22) Filed: Apr. 18, 2025

Related U.S. Application Data
(63) Continuation of application No. PCT/CN2023/086477, filed on Apr. 6, 2023.

(51) Int. Cl. H04W 74/08; H04W 92/18

(52) U.S. Cl. CPC H04W 74/0875; H04W 92/18

(57) ABSTRACT

Presented are systems and methods for performing sidelink Channel Occupancy Time (COT) sharing on unlicensed carrier. A first wireless communication device may send a first message including Channel Occupancy Time (COT) assistance information to a second wireless communication device. The second wireless communication device can initiate sharing of a COT with the first wireless communication device.

### CROSS-REFERENCE TO RELATED APPLICATION

This application claims the benefit of priority under 35 U.S.C. § 120 as a continuation of International Patent Application No. PCT/CN2023/086477, filed on Apr. 6, 2023, the disclosure of which is incorporated herein by reference in its entirety.

### TECHNICAL FIELD

The disclosure relates generally to wireless communications, including but not limited to systems and methods for performing sidelink Channel Occupancy Time (COT) sharing on an unlicensed carrier/shared spectrum.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A first wireless communication device (e.g., a responding UE) may send a first message including Channel Occupancy Time (COT) assistance information to a second wireless communication device (e.g., a initiating UE). The second wireless communication device can initiate sharing of a COT with the first wireless communication device. The COT assistance information may comprise one or more sets of parameters for each of a plurality of Channel Access Priority Class (CAPC) values, each of the sets of parameters associated with one or more logical channels. Each of the sets of parameters may comprise at least one of the following information: trafficPeriodicity, Duration, RBNum, SubbandNum, MintimingOffset, MaxtimingOffset, or Buffer size information. When one of the CAPC values is associated with multiple logical channels, the COT assistance information may include multiple sets of the parameters for the CAPC value. When one of the CAPC values is associated with multiple logical channels, the Buffer size information or a size of data estimated arrival may correspond to a sum of all the associated logical channels.

In some embodiments, the COT assistance information may only include parameters for one or more logical channels associated with respective dedicated destination ID(s). The COT assistance information may include a buffer size field and a CAPC value field, the buffer size field being configured to indicate a total amount of data available across all logical channels associated with a CAPC value, the CAPC value field being configured to indicate a CAPC value of one or more logical channels with a reported sidelink buffer status.

In some embodiments, the first wireless communication device may determine that at least one of the following conditions is met so as to send the COT assistance information: (1) content of the COT assistance information has changed; (2) sidelink data for a logical channel has become available, and the sidelink data belongs to a logical channel with a higher priority than a priority of any other logical channel containing available sidelink data; (3) sidelink data for a logical channel associated with a higher priority CAPC value has become available; (4) sidelink data for a logical channel associated with a lower priority CAPC value has become available; (5) an LBT failure has been detected; (6) a timer has been expired; (7) the first wireless communication device has received a second message from the second wireless communication device, indicating that the second wireless communication device can provide the COT; or (8) LBT failure has been detected for X times. A value of timer or a number of X can be configured by the network, or preconfigured. The timer can be started or restarted upon the COT assistance information is sent.

In some embodiments, the first wireless communication device may receive, from the second wireless communication device, a second message indicating the sharing of the COT, before sending the COT assistance information. The second message may further indicate one or more destination IDs. The COT assistance information may include multiple sets of parameters, with their respective values sequentially indexed in a same order presented in the second message. The first wireless communication device can be selected by the second wireless communication device for the sharing of the COT, when at least one of the following conditions is met: (1) an indicated CAPC value in the COT assistance information is equal to or smaller than a CAPC value associated with a COT resource and a lowest CAPC value; (2)an indicated CAPC value in the COT assistant information is equal to or smaller than a CAPC value associated with a COT resource and a highest CAPC value; or (3) a size of data estimated arrival or in buffer in the COT assistant information is largest, wherein a CAPC value of the data is equal to or smaller than a CAPC value associated with a COT resource.

In some embodiments, in response to acquiring a first sidelink grant, initiating, by a first wireless communication device (e.g., a responding UE), a Logical Channel Prioritization (LCP) procedure for performing a sidelink transmission, wherein the LCP procedure further comprises: selecting, by the first wireless communication device, one from a plurality of destinations on a list; and selecting, by the first wireless communication device, one or more from a plurality of logical channels belonging to the selected destination. The first sidelink grant can be associated with one or more Channel Occupancy Times (COTs) shared by one or more second wireless communication devices with the first wireless communication device. The COT can be received from multiple different UEs. The shared resource in different COTs have overlapping. For some grants (e.g., in overlapping part), the shared resource may correspond to multiple COTs.

In some embodiments, the first wireless communication device may identify that the first sidelink grant is associated with a single COT that corresponds to a designated destination ID and a designated CAPC value. The first wireless communication device may select the destination, with the designated destination ID, that has sidelink data available for transmission and a CAPC value equal to or smaller than the designated CAPC value. The first wireless communication device may select the logical channel having sidelink data available for transmission and a CAPC value equal to or smaller than the designated CAPC value.

In some embodiments, the first wireless communication device may identify that the first sidelink grant is associated at least with a first COT that corresponds to a first designated destination ID and a first designated CAPC value, and a second COT that corresponds to a second designated destination ID and a second designated CAPC value. The first wireless communication device may select the destination, with the first or second designated destination ID, that has sidelink data available for transmission and a CAPC value equal to or smaller than the first or second designated CAPC value. The first wireless communication device may select the logical channel having sidelink data available for transmission and a CAPC value equal to or smaller than the first or second designated CAPC value.

In some embodiments, the first wireless communication device may identify that the first sidelink grant is associated at least with a first COT that corresponds to a first designated destination list and a first designated CAPC value, and a second COT that corresponds to a second designated destination list and a second designated CAPC value. The first wireless communication device may select the destination, on the first or second designated destination list, that has sidelink data available for transmission and a CAPC value equal to or smaller than the first or second designated CAPC value, in which a logical channel of the selected destination has a highest priority. The first wireless communication device may select the logical channel having sidelink data available for transmission and a CAPC value equal to or smaller than the first or second designated CAPC value.

In some embodiments, the first wireless communication device may receive a message indicating sharing of the one or more COTs from the second wireless communication device.

In some embodiments, if no destination is selected in any of above embodiments, the first wireless communication device may select the destination having at least one of its MAC CE or a logical channel with a highest priority.

In some embodiments, the first wireless communication device may determine that a type 1 Listen-Before-Talk (LBT) procedure for the grant will fail. If no destination is selected in any of above embodiments, the first wireless communication device may select no destination.

In some embodiments, the first wireless communication device may determine that a type 1 LBT procedure for the grant will succeed. If no destination is selected in any of above embodiments, the first wireless communication device may select the destination having at least one of its MAC CE or a logical channel with a highest priority.

In some embodiments, the first wireless communication device may identify that a size of a remaining portion of the first sidelink grant is equal to or smaller than N bytes. The first wireless communication device may transmit a padding.

In some embodiments, the first wireless communication device may identify that a size of a remaining portion of the first sidelink grant is equal to or larger than N bytes and determine a type 1 LBT procedure for the grant will fail. The first wireless communication device may transmit a padding.

In some embodiments, the first wireless communication device may identify that a size of a remaining portion of the first sidelink grant is equal to or larger than N bytes. The first wireless communication device may select the logical channel regardless of a CAPC value.

In some embodiments, the first wireless communication device may identify that a size of a remaining portion of the first sidelink grant is equal to or larger than N bytes to determine a type 1 LBT procedure for the grant will succeed. The first wireless communication device may select the logical channel regardless of a CAPC value.

In some embodiments, the first wireless communication device may acquire M (more than one) sidelink grants that correspond to the same COT that corresponds to a designated destination ID list and a designated CAPC value. In response to determining that the first sidelink grant is a first one of the M sidelink grants, the first wireless communication device may select the destination, from the designated destination ID list, that has sidelink data available for transmission and a CAPC value equal to or smaller than the designated CAPC value; the first wireless communication device may select the logical channel having sidelink data available for transmission and a CAPC value equal to or smaller than the designated CAPC value.

In some embodiments, the first wireless communication device may acquire M (more than one) sidelink grants that correspond to the same COT that corresponds to a designated destination ID list (e.g., one or mode destination IDs) and a designated CAPC values. The first wireless communication device may determine that the first sidelink grant is not a first one of the M sidelink grants, and a destination from the designated destination ID list has been selected for a previous one of the M sidelink grants. The first wireless communication device may select the destination having at least one of its MAC CE or a logical channel with a highest priority.

In some embodiments, the first wireless communication device may acquire M (more than one) sidelink grants that correspond to the same COT that corresponds to a designated destination ID list and a designated CAPC value. The first wireless communication device may determine that the first sidelink grant is not the first one of the M sidelink grants, and a destination from the designated destination ID list has been selected, and no indication of a LBT failure has been received for a previous one of the M sidelink grants. The first wireless communication device may select the destination having at least one of its MAC CE or a logical channel with a highest priority.

In some embodiments, the first wireless communication device may acquire M (more than one) sidelink grants that correspond to the same COT that corresponds to a designated destination ID list and a designated CAPC value. The first wireless communication device may determine that the first sidelink grant is not the first one of the M sidelink grants, and a destination from the designated destination ID list has not been selected for a previous one of the M sidelink grants. The first wireless communication device may select the destination, from the designated destination ID list, that has sidelink data available for transmission and a CAPC value equal to or smaller than the designated CAPC value. The first wireless communication device may select the logical channel having sidelink data available for transmission and a CAPC value equal to or smaller than the designated CAPC value.

In some embodiments, the first wireless communication device may acquire M (more than one) sidelink grants that correspond to the same COT that corresponds to a designated destination ID list and a designated CAPC values. The first wireless communication device may determine that the first sidelink grant is a the last one of the M sidelink grants and a destination from the designated destination ID list has been selected for a previous one of the M sidelink grants. The first wireless communication device may select the destination having at least one of its MAC CE or a logical channel with a highest priority.

In some embodiments, the first wireless communication device may acquire M (more than one) sidelink grants that correspond to the same COT that corresponds to a designated destination ID list and a designated CAPC value. The first wireless communication device may determine that the first sidelink grant is the last one of the M sidelink grants, and a destination from the designated destination ID list has not been selected for a previous one of the M sidelink grants. The first wireless communication device may select the destination, from the designated destination ID list, that has sidelink data available for transmission and a CAPC value equal to or smaller than the designated CAPC value. The first wireless communication device may select the logical channel having sidelink data available for transmission and a CAPC value equal to or smaller than a designated CAPC value.

In some embodiments, the first wireless communication device may acquire M (more than one) sidelink grants that correspond to the same COT that corresponds to a designated destination ID list and a designated CAPC value. The first wireless communication device may determine that the first sidelink grant is the last one of the M sidelink grants and a destination from the designated destination ID list has been selected and no indication of a LBT failure has been received for a previous one of the M sidelink grants. The first wireless communication device may select the destination having at least one of its MAC CE or a logical channel with a highest priority.

In some embodiments, the first wireless communication device may acquire M (more than one) sidelink grants that correspond to the same COT that corresponds to a designated destination ID list and a designated CAPC value. The first wireless communication device may determine that the first sidelink grant is not the last one of the M sidelink grants. The first wireless communication device may select the destination having at least one of its MAC CE or a logical channel with a highest priority.

In some embodiments, a second wireless communication device may receive a first message including first Channel Occupancy Time (COT) assistance information from a first wireless communication device. The second wireless communication device can initiate sharing of a COT with the first wireless communication device. The second wireless communication device may receive a third message including second COT assistance information from a third wireless communication device. The second wireless communication device may select the first wireless communication device for the sharing of the COT, when at least of the following conditions is met: (1) an indicated CAPC value in the first COT assistance information is equal to or smaller than a CAPC value associated with a COT resource and a lowest CAPC value; (2) an indicated CAPC value in the first COT assistant information is equal to or smaller than a CAPC value associated with a COT resource and a highest CAPC value; or (3) a size of data estimated arrival or in buffer in the first COT assistant information is largest, wherein a CAPC value of the data is equal to or smaller than a CAPC value associated with a COT resource.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an example of a wireless communication system, in accordance with some embodiments of the present disclosure;

FIG. 4 illustrates a flow diagram of an example method for wireless communication that includes detecting for listen-before-talk (LBT) failures, in accordance with an embodiment of the present disclosure; and

FIG. 5 illustrates a flow diagram of an example method for performing sidelink Channel Occupancy Time (COT) sharing on unlicensed carrier, in accordance with an embodiment of the present disclosure.

### DETAILED DESCRIPTION

### 1. Mobile Communication Technology and Environment

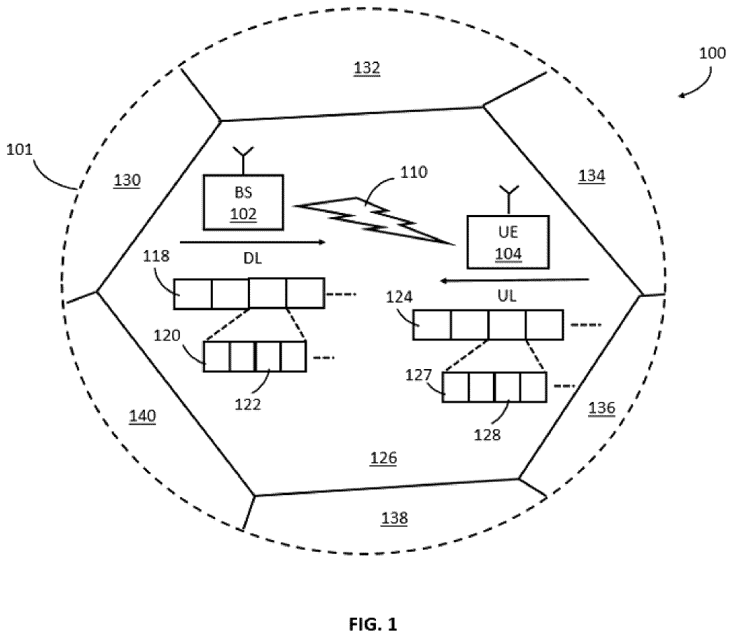

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

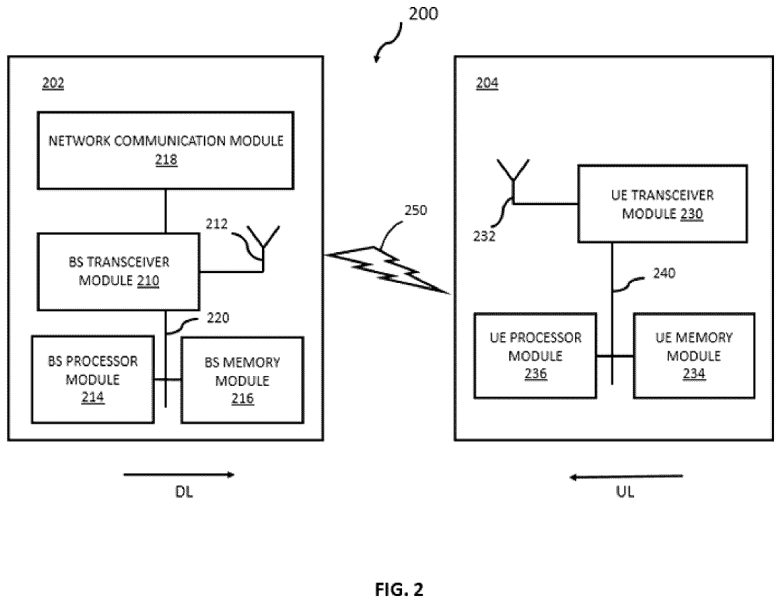

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise. 2. Systems and Methods for Performing Sidelink Channel Occupancy Time (COT) Sharing on Unlicensed Carrier

Wireless communications are often performed with user terminal devices and base stations. In addition, wireless communication is performed on carriers or frequency bands. Some carriers are licensed carriers, which are carriers licensed by a governmental or other authoritative entity to a service provider for exclusive use. Other carriers are unlicensed carriers, which are carriers not licensed by such governmental or other authoritative entities. Currently, user terminal devices communicate directly with each other (i.e., without use of a base station) on licensed carriers. However, ways for user terminal devices to communicate directly with each other on unlicensed carriers may be desirable.

The present description describes various embodiments of systems, apparatuses, devices, and methods for wireless communications involving sidelink transmissions, including those in unlicensed carriers.

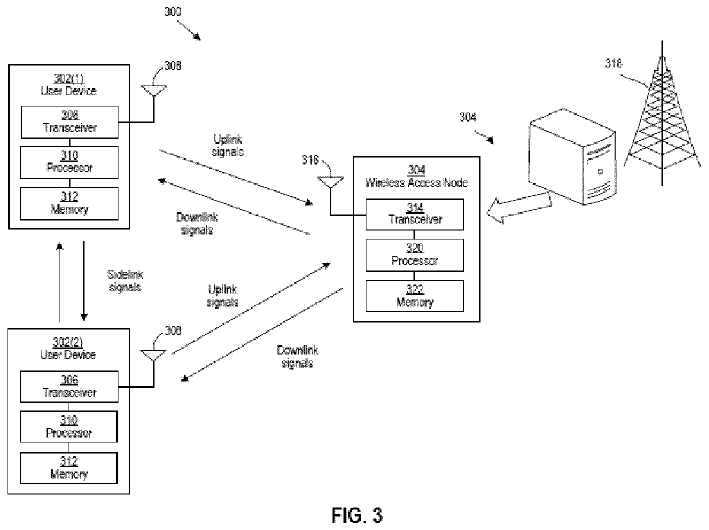

FIG. 3 shows a diagram of an example wireless communication system 300 including a plurality of communication nodes (or just nodes) that are configured to wirelessly communicate with each other. In general, the communication nodes include at least one user device 302 and at least one wireless access node 304. The example wireless communication system 300 in FIG. 3 is shown as including two user devices 302, including a first user device 302(1) and a second user device 302(2), and one wireless access nodes 304. However, various other examples of the wireless communication system 300 that include any of various combinations of user devices 302 and wireless access nodes 304, including two or more user devices 302 without any wireless access nodes 304, only one user device 302 and only one wireless access node 304, only one user device 302 and two or more wireless access nodes 304, two or more user devices 302 and one or more wireless access nodes 304, or two or more wireless access nodes 304 without any user devices 302.

In general, a user device as described herein, such as the user devices 302, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 302 may include transceiver circuitry 306 coupled to an antenna 308 to effect wireless communication with the wireless access node 304. The transceiver circuitry 306 may also be coupled to a processor 310, which may also be coupled to a memory 312 or other storage device. The memory 312 may store therein instructions or code that, when read and executed by the processor 310, cause the processor 310 to implement various ones of the methods described herein.

Additionally, in general, a wireless access node as described herein, such as the wireless access node 304, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 304. For example, the wireless access node 304 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 304 may include transceiver circuitry 314 coupled to an antenna 316, which may include an antenna tower 318 in various approaches, to effect wireless communication with the user device 302 or another wireless access node 104. The transceiver circuitry 314 may also be coupled to one or more processors 320, which may also be coupled to a memory 322 or other storage device. The memory 322 may store therein instructions or code that, when read and executed by the processor 320, cause the processor 320 to implement one or more of the methods described herein.

In various embodiments, two communication nodes in the wireless system 300—such as a user device 302 and a wireless access node 304, two user devices 302 without a wireless access node 304, or two wireless access nodes 304 without a user device 302—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in various embodiments, two or more of the communication nodes in the wireless system 300, may be configured to communicate according to vehicle networking standards and/or specifications. As used herein, vehicle networking refers to a large scale system for wireless communication and information exchange involving a vehicle, pedestrians, roadside equipment and the Internet in accordance with any of various communication protocols and data exchange standards. Vehicle networking communications may enhance vehicle performance with respect to driving safety, traffic efficiency, usability or user convenience features, or entertainment. Additionally, in any of various embodiments, vehicle networking communication may be categorized into three types: communication between vehicles (also called vehicle-to-vehicle (V2V)); communication between a vehicle and roadside equipment/network infrastructure (called vehicle-to-infrastructure/vehicle-to-network (V2I/V2N)); and communication between vehicles and pedestrians (called vehicle-to-pedestrian (V2P)). These types of communications are collectively referred to as vehicle-to-everything (V2X) communication. Communication nodes participating in V2X communicates may communicate with each other according to any of various V2X standards or specifications.

In the wireless system 300, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 300 can both send and receive signals, a single communication node may be both a transmitting/source node and a receiving/destination node simultaneously or switch between being a sending node and a receiving node.

Also, particular signals can be characterized or defined as either an uplink (UL) signal, a downlink (DL) signal, or a sidelink (SL) signal. An uplink signal is a signal transmitted from a user device 302 to a wireless access node 304. A downlink signal is a signal transmitted from a wireless access node 304 to a user device 302. A sidelink signal is a signal transmitted from a one user device 302 to another user device 302, or a signal transmitted from one wireless access node 304 to a another wireless access node 304. Also, for sidelink transmissions, a first/source user device 302 directly transmits a sidelink signal to a second/destination user device 302 without any forwarding of the sidelink signal to a wireless access node 304.

For at least some embodiments involving V2X communication, user devices 302 may perform sidelink transmissions. Such sidelink communications in V2X may be referred to as a PC5-based V2X communication or V2X communication. Additionally, for sidelink communications in V2X, user device 102 may communicate sidelink signals to each other using a PC5 interface, where PC5 refers to a reference point where a user device 302 communicates with another user device 302 over a direct channel.

As V2X technology advances, including in the automation industry, scenarios for V2X communications are being increasingly diversified and require higher performance. Examples of advanced V2X services include vehicle platooning, extended sensors, advanced driving (semi-automated driving and full-automated driving), and remote driving. Example performance requirements for these advanced V2X services may include: supporting data packets with a size of 50 to 12,000 bytes, a transmission rate of 2 to 50 messages per second, a maximum end-to-end delay of 3 to 500 milliseconds, a reliability of 90% to 99.999%, a date rate of 0.5 to 1,000 Megabytes per second (Mbps), or a transmission range of 50 to 1,000 meters, as non-limiting examples.

In addition, communication nodes using NR radio access operating with shared spectrum channel access may be configured to operate in different modes, where primary cells (PCells), primary secondary cells (PSCells) or secondary cells (SCells) can be in the shared spectrum, and an SCell may or may not be configured with uplink transmissions. Further, in both channel access modes, the wireless access node 304 and the user device 302 may be configured to apply or perform listen-before-talk (LBT) procedures before performing a transmission on a cell configured with shared spectrum channel access.

### Implementation Example 0: LBT and CAPC

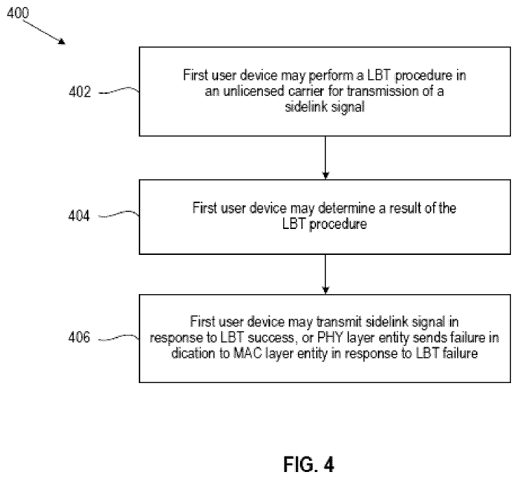

FIG. 4 shows an example method 400 for wireless communication that includes sidelink communication between the first user device 302(1) and the second user device 302(2) on an unlicensed carrier. The embodiments of the method 400 have the first user device 302(1) functioning as a source or transmitting user device that transmits a sidelink signal to the second user device 302(2), and the second user device 302(2) functioning as a destination or receiving user device that receives the sidelink signal from the first user device 302(1).

Also, in general, a licensed carrier is a carrier, frequency band or spectrum that is licensed by a government or other authoritative entity (e.g., the Federal Communications Commission (FCC) in the United States or the European Telecommunications Standards Institute (ETSI) in Europe) to a service provider for exclusive use. An unlicensed carrier, also called a shared spectrum, is a carrier, frequency band or spectrum that is not licensed by a government or other authoritative entity.

At block 402, the first user device 302(1) may perform a listen-before-talk (LBT) procedure in an unlicensed carrier for transmission of a sidelink signal. In general, when a user device 302 wants to transmit a signal (e.g., an uplink signal or a sidelink signal) on a channel in a particular carrier (unlicensed), the user device may perform an LBT procedure in the carrier before transmitting the signal. During an LBT procedure, the user device 302 may listen to or sense the channel to determine whether the channel is available (free) or busy. In response to, or as a result of, performing the LBT procedure, the user device 302 may determine whether the LBT procedure is a success or a failure. A success indicates that the channel is available, and in turn, the user device 302 can proceed to transmit the signal. A failure indicates that the channel is busy, and in turn, the user device 302 determines not to transmit the signal.

In various embodiments, at block 402, the first user device 302(1) may perform the LBT procedure according to a sidelink channel access priority. In particular, during the LBT procedure, an amount of time that the first device 302 has to monitor the channel may depend on a value of the sidelink channel access priority. Also, in the event that the LBT procedure is a success, an amount of time resources the channel occupies may depend on the value of the sidelink channel access priority.

In some of these embodiments, the sidelink channel access priority is a sidelink channel access priority of a sidelink logical. For example, the first user device 302(1) may be configured with a plurality of logical channels, and each logical channel may have or be mapped to an associated priority value for a sidelink channel access priority. The priority values may be the same as or different from each other for the different logical channels. Correspondingly, when the first user device 302(1) determines to transmit data (e.g., data of a MAC protocol data unit (PDU)) as part of the sidelink signal, the first user device 302(1) may determine a logical channel that corresponds to the data, and in turn, determine a priority value corresponding to the logical channel. The first user device 302(1) may then perform the LBT procedure according to the determined priority value.

### Implementation Example 1: COT Assistant Information

During sidelink on unlicensed bands (SL-U), when a UE (e.g., Channel Occupancy Time (COT) initiating UE) obtains a COT on SL-U, the UE can initiate a COT shared with one or multiple responding UEs. However, the imitating UE may have no knowledge on the traffic pattern or buffer size information of the candidate COT responding UEs. If there are multiple candidate responding UEs, it can be hard to determine which UE can be selected to initiate a COT shared with. If the selected COT responding UE has no available data to send during the shared COT, this COT can be wasted. To solve this issue, before the UE initiate a COT shared with one or multiple responding UEs, the UE may receive COT assistant information from at least one of responding UEs.

### Implementation Example 1-1: Content of COT Assistant Information

If a UE can be a candidate COT responding UE, the UE can send the COT assistant information to the candidate COT initiating UE. The COT assistant information may include a traffic pattern or buffer size information of the UE.

In some embodiments, COT assistant information may include at least one of: a traffic periodicity, a duration, a RBNum OR SubbandNum, a MintimingOffset, a MaxtimingOffset, a channelAccessPriority, or buffer size information. The trafficPeriodicity may indicate the estimated data arrival periodicity (e.g., value ms20 corresponds to 20 ms, ms50 corresponds to 50 ms). The duration may indicate an estimated data arrival duration. The RBNum OR SubbandNum may indicate a maximum number of RB or subband based on the observed traffic pattern. The MintimingOffset may indicate a minimum estimated timing for a packet arrival. The MaxtimingOffset may indicate a maximum estimated timing for a packet arrival. The channelAccessPriority may indicate a channel access priority of estimated data arrival. The buffer size information may indicate buffer size information.

### Implementation Example 1-1-1: One Set of Parameters

If SL data for multiple logical channels which are associated to different Channel Access Priority Class (CAPC) values is available, and the COT assistant information only includes one set of parameters, at least one of the following steps for setting the CAPC value in the COT assistant information can be considered: select the lowest CAPC value of the logical channels which are available or select the highest CAPC value of the logical channels which are available.

### Implementation Example 1-1-2: One Set of Parameters

If SL data for multiple logical channels which are associated to different Channel Access Priority Class (CAPC) values is available or will be available, COT assistant information may include N sets of parameters, and one set of parameters can be associated with one CAPC value.

If SL data for multiple logical channels which are associated with N CAPC values is available, the COT assistant information may include N sets of parameters, and one set of parameters is associated with one CAPC value.

For example, if SL data is available or be predicted for logical channel 1 which is configured with CAPC value 1 and SL data is available for logical channel 2 which is configured with CAPC value 2, the UE can determine at least one of: a trafficPeriodicity, a duration, a RBNum, a SubbandNum, a MintimingOffset, a MaxtimingOffset, or buffer size information for logical channel 1 and/or logical channel 2. The UE can send the COT assistant information which include at least one of above parameters for CAPC value 1 and/or CAPC value 2 to other candidate COT initiating UE. COT assistant information may include one or more sets of parameters of logical channel(s) for each CAPC value. A set of parameters may be at least one of: a trafficPeriodicity, a duration, a RBNum, a SubbandNum, a MintimingOffset, a MaxtimingOffset, or buffer size information.

For another example, if SL data is available for logical channel 1 which is configured with CAPC value 1 and SL data is available for logical channel 2 and 3 which are both configured with CAPC value 2, the UE can determine at least one of a trafficPeriodicity, a duration, a RBNum, a SubbandNum, a MintimingOffset, a MaxtimingOffset, or buffer size information for logical channel 1 and/or logical channel 2/3. The UE can send the COT assistant information which include at least one of above parameters for CAPC value 1 and/or CAPC value 2 to other candidate COT initiating UE. For CAPC value 2, since it is associated with two logical channels, the CAPC value 2 may be associated with two sets parameters of trafficPeriodicity, duration, RBNum, SubbandNum, MintimingOffset, MaxtimingOffset, or buffer size information. However, if the trafficPeriodicity, the MintimingOffset, or the MaxtimingOffset are the same or very similar for logical channel 2 and 3, the CAPC value 2 can be associated with only one set of parameters of trafficPeriodicity, duration, RBNum, SubbandNum, MintimingOffset, MaxtimingOffset, or buffer size information. For this case, the RBNum, SubbandNum, or Buffer size information may be the sum of the logical channel 2 and 3.

If CAPC value x is associated with more than one logical channels, the COT assistant information can include one or more sets of parameters for CAPC value x.

If the traffic of logical channel L has no period characters, the sets of parameters may not include trafficPeriodicity. The sets of parameters can include Buffer size information for each CAPC value. If one CAPC value is associated with multiple logical channels, the buffer size may be a sum of all the associated logical channels.

If CAPC value x is associated with more than one logical channels, the COT assistant information can include one or more sets of parameters for CAPC value x.

In some embodiments, if SL data is available for logical channel 1 which is configured with CAPC value 1 and SL data is available for logical channel 2 and 3 which are both configured with CAPC value 2, the logical channel 1 can be associated with destination ID 1, logical channel 2 can be associated with destination ID 2, and logical channel 3 can be associated with destination ID 3.

In addition, if the COT resource from candidate COT initiating UE-1 can be used for the sidelink transmission associated with destination ID 1, the COT resource from candidate COT initiating UE-2 can be used for the transmission associated to destination ID 2, and the COT resource from candidate COT initiating UE-3 can be used for the sidelink transmission associated to destination ID 3.

The UE may send the COT assistant information which only include the parameters for logical channel 1 with CAPC value 1 to candidate COT initiating UE-1. The UE may send the COT assistant information which only include the parameters for logical channel 2 with CAPC value 2 to candidate COT initiating UE-2. The UE may send the COT assistant information which only include the parameters for logical channel 3 with CAPC value 2 to candidate COT initiating UE-3. COT assistant information may only include parameters for logical channel(s) associated to dedicated destination ID(s). The dedicated destination ID(s) can be corresponding to candidate COT initiating UE.

### Implementation Example 1-2: When to Send COT Assistant Information

If the SL resources are allocated when configured with network schedule mode or SL resources are selected when configured with UE selected mode, and number of padding bits is equal to or larger than the size of the COT assistant information plus its subheader, the UE can send the COT assistant information. In such case, the COT assistant information can be carried in a SL MAC CE.

The COT assistant information may include a buffer size field and a CAPC value field. The buffer size field may identify the total amount of data available across all logical channels of a CAPC value of a destination. The CAPC value field may identify the CAPC value of logical channel(s) whose SL buffer status is being reported. The length of the field can be 2 bits.
1> if the number of padding bits is equal to or larger than the size of the field including only one of CAPC value and buffer size plus its subheader but smaller than the size of the field including all CAPC value and buffer size plus its subheader:
2> if more than one logical channels associated to more than one CAPC values have data available for transmission,
report the CAPC value and buffer size with the highest priority logical channel with data available for transmission; or
report the CAPC value and buffer size with the lowest priority logical channel with data available for transmission; or
report the CAPC values and buffer size(s) with the logical channels having data available for transmission following a decreasing order of the highest priority logical channel associated to each of these CAPC(s); or
report the CAPC values and buffer size(s) with the logical channels having data available for transmission following a increasing order of the highest priority logical channel associated to each of these CAPC(s).
1> if the number of padding bits is equal to or larger than the size of size of the field including all CAPC value and buffer size plus its subheader:
2> report the CAPC values and buffer size(s) for all logical channels which have data available for transmission.

If a UE can be a candidate COT responding UE, the UE can send the COT assistant information to the candidate COT initiating UE when at least one of following conditions is met:
the content of COT assistant information is changed; SL data for a logical channel becomes available, and this SL data belongs to a logical channel with higher priority than the priority of any logical channel containing available SL data which is associated to any CAPC value; SL data for a logical channel associated with a higher priority CAPC value becomes available; SL data for a logical channel associated to a smaller priority CAPC value becomes available; LBT failure is detected; a timer is expired; or upon receiving the message from candidate COT initiating UE, the message that indicates the candidate COT initiating UE can share COT resource.

### Implementation Example 1-3: COT Initiating UE Trigger

If a UE can be a COT initiating UE, the UE can send the COT share indication to one or more candidate COT responding UEs before it send the COT information to a COT responding UE. The COT share indication can indicate the UE to provide COT share resource. In addition, the COT share indication can also carry CAPC value, which indicates the allowed CAPC value(s) or the allowed highest CAPC value(s) when the COT responding UE uses the COT resource. In addition, the COT share indication can carry destination ID list which indicates the destination ID can use the COT resource.

In some embodiments, after a candidate COT responding UE receives the COT share indication, the UE can send the COT assistant information to the candidate COT initiating UE.

In some embodiments, after a candidate COT responding UE receives the COT share indication with CAPC value, the UE can send the COT assistant information including one or multiple sets parameters associated with the CAPC value lower smaller than or equal to the value indicated in the COT share indication to the candidate COT initiating UE.

In some embodiments, after a candidate COT responding UE receives the COT share indication with destination ID list, the UE can send the COT assistant information including one or multiple sets parameters associated with the destination ID(s) indicated in the COT share indication to the candidate COT initiating UE. When multiple sets parameters are included in the COT assistant information, the value can be indexed sequentially across all the lists in the same order as presented in COT share indication.

In some embodiments, the COT share indication can be carried in sidelink control information (SCI), MAC CE or SL RRC message.

### Implementation Example 2: Receiving COT Assistant Information

After a second UE (e.g., COT initiating UE) receives a COT assistant information, the UE can take the COT assistant information into consideration when deciding which UE is COT responding UE(s).

In some embodiments, the second UE (e.g., COT initiating UE) receives multiple COT assistant information from multiple candidate COT responding UEs. For a COT resource, if there are multiple candidate COT responding UEs can use the COT resource based on the COT assistant information, the UE may select the COT responding UE for a COT according to at least one of following solutions: the indicated CAPC value in the COT assistant information is equal to or smaller than the CAPC value associated to the COT resource and the lowest one; the indicated CAPC value in the COT assistant information is equal to or smaller than the CAPC value associated to the COT resource and the highest one; or the size of data estimated arrival or in buffer is the largest one, wherein the CAPC value of the data is equal to or smaller than the CAPC value associated to the COT resource.

### Implementation Example 3: Logical Channel Prioritization (LCP)

Based on the existing LCP procedure, UE needs to select the destination at the first step and then select the LCHs belonging to this destination and satisfying some other defined conditions, e.g., CG and/or HARQ limitation.

In some embodiments, when the first UE acquires a sidelink grant, if the UE wants to use COT resource and performs type 2 LBT detection, the data multiplexed in the grant can satisfy some conditions (e.g., there is data to the initiating UE and the CAPC of the data is smaller than or equal to the CAPC indicated in COT information). Otherwise, the UE may have to perform type 1 LBT.

After the first UE acquires a sidelink grant, the UE may decide which type of LBT can be used for this transmission.

In some embodiments, if the grant is not corresponding to any shared COT, or the grant is corresponding to a shared COT but the UE decides the type 1 LBT may be success, the UE can perform a Logical Channel Prioritization (LCP) procedure. If the grant is corresponding to any shared COT, the UE may consider to select the destination indicated in COT information firstly during LCP procedure.

### Implementation Example 3-1: One COT Case

When the first UE acquires a sidelink grant, the first UE may perform a sidelink Logical Channel Prioritization (LCP) procedure to obtain a medium access control protocol data unit (MAC PDU) to transmit. During the sidelink Logical Channel Prioritization procedure, the UE may determine which destination identifier (ID) can be selected. The first UE may further determine which logical channels can be selected for the selected destination ID.

In some embodiments, a first UE may acquire a first COT from a second UE or the network (e.g., gNB). If the first UE acquires a sidelink grant, at least one of following cases can be performed.

Case 1: if the sidelink grant is corresponding to a first shared COT, or the sidelink grant is corresponding to a first shared COT and the type 1 LBT may fail for this grant. The first COT resource is associated with one destination-x and a CAPC value-x. During the sidelink Logical Channel Prioritization procedure, the first UE may select the Destination-x in case that this destination may have at least one of: the MAC CE and the logical channel with SL data available for transmission, and the CAPC value is equal to or smaller than the associated CAPC value-x.

In some embodiments, the first UE may select the MAC CE or logical channels satisfying all the following conditions among the logical channels belonging to the selected destination: SL data is available for transmission; and the CAPC value is equal to or smaller than the associated CAPC value.

Case 2: if the sidelink grant is related to the first COT resource, the first COT resource can be associated with a list of (more than one) destination(s) and a CAPC value-x. During the sidelink Logical Channel Prioritization procedure, the first UE may select the destination from the list of destination(s) in case that any destination belonging to the list having at least one of the MAC CE and the logical channel with the highest priority, among the logical channels that satisfy all the following conditions and MAC CE(s). The logical channel with SL data available for transmission and the CAPC value can be equal to or smaller than the associated CAPC value-x. The first UE may select the MAC CE or logical channels satisfying all the following conditions among the logical channels belonging to the selected destination: SL data is available for transmission; and the CAPC value is equal to or smaller than the CAPC value associated to the selected Destination or the COT.

For both case 1 and case 2, if destination-x or any destination belonging to list of destination(s) having neither MAC CE nor the logical channel with SL data available for transmission and the CAPC value is equal to or smaller than the associated CAPC value-x, at least one of following situations can be performed.

In some embodiments, the UE may perform a LCP procedure. For example, the UE may select a Destination having at least one of the MAC CE and the logical channel with the highest priority, among the logical channels that satisfy some conditions.

In some embodiments, if the UE determines type 1 LBT can fail for this grant, the UE may ignore this grant, alternatively, the UE may select nothing for this grant.

In some embodiments, if the UE determines type 1 LBT may success for this grant, the UE may perform a LCP procedure. For example, the UE may select a Destination having at least one of the MAC CE and the logical channel with the highest priority, among the logical channels that satisfy some conditions.

Case 3: if the sidelink grant is related to the first COT resource, the first COT resource can be associated with a CAPC value-x. During the sidelink Logical Channel Prioritization procedure, the first UE may select the Destination having at least one of the MAC CE and the logical channel with the highest priority, among the logical channels that satisfy all the following conditions and MAC CE(s): the logical channel with SL data available for transmission and the CAPC value is equal to or smaller than the associated CAPC value-x.

The first UE may select the MAC CE or logical channels satisfying all the following conditions among the logical channels belonging to the selected Destination: SL data is available for transmission; and the CAPC value is equal to or smaller than the CAPC value associated to the selected Destination or the COT.

For all above case 1, 2 and 3, after the first UE selects the MAC CE or logical channels satisfying all the conditions, at least one of following situations can be performed.

In certain embodiments, if the left sidelink grant size is equal to or smaller than N bytes, the MAC entity can transmit padding.

In certain embodiments, if the left sidelink grant size is equal to or larger than N bytes and the UE determines type 1 LBT can fail for this grant, the UE can transmit padding.

In certain embodiments, if the left sidelink grant size is equal to or larger than N bytes, the UE can select the MAC CE or logical channel(s) belonging to the selected Destination regardless CAPC value.

In certain embodiments, if the left sidelink grant size is equal to or larger than N bytes and the UE determines type 1 LBT may success for this grant, the UE can select the MAC CE or logical channel(s) belonging to the selected Destination regardless CAPC value of the logical channel(s).

In some embodiments, the value N can be configured by the network, can be preconfigured, or can be defined.

### Implementation Example 3-2: UE Acquires Grant Corresponding to Multiple COT

In some embodiments, a first UE may acquire a first COT from a second UE or the network, and/or may acquire a second COT from a third UE or the network (e.g., gNB). If the first UE acquires a sidelink grant, and if the sidelink grant is related to the first COT resource and a second COT resource, the first COT resource can be associated with one destination-x and a CAPC value-x, the second COT resource can be associated with one destination-y and a CAPC value-y. During the sidelink Logical Channel Prioritization procedure, the first UE may select the Destination from the list of [destination-x, destination-y] in case that any destination belonging to the list having at least one of the MAC CE and the logical channel with the highest priority, among the logical channels that satisfy all the following conditions: the logical channel with SL data available for transmission; and the CAPC value of the logical channel belonging to destination-x is equal to or smaller than the CAPC value-x; or the CAPC value of the logical channel belonging to destination-y is equal to or smaller than the CAPC value-y.

In some embodiments, the first UE may select the Destination from the list of [destination-x, destination-y] in case that any destination belonging to the list having at least one of the MAC CE and the logical channel with the highest buffer size, among the logical channels that satisfy all the following conditions: the logical channel with SL data available for transmission; and the CAPC value of the logical channel belonging to destination-x is equal to or smaller than the CAPC value-x; or the CAPC value of the logical channel belonging to destination-y is equal to or smaller than the CAPC value-y.

The first UE may select the MAC CE or logical channels satisfying all the following conditions among the logical channels belonging to the selected Destination: SL data is available for transmission; and the CAPC value is equal to or smaller than the CAPC value associated with the selected Destination.

For another embodiment, if the sidelink grant is related to the first COT resource and a second COT resource, and the first COT resource is associated with one destination-x and a CAPC value-x, the second COT resource can be associated with one destination-y and a CAPC value-y, the UE may ignore this grant, alternatively, the UE may select nothing for this grant.

If the sidelink grant is related to the first COT resource and a second COT resource, and the first COT resource is associated with a list-x of destination(s) and a CAPC value-x, the second COT resource can be associated with a list-y of destination(s) and a CAPC value-y. During the sidelink Logical Channel Prioritization procedure, the first UE may select the Destination from the list x and list y of destination(s) in case that any destination belonging to the list having at least one of the MAC CE and the logical channel with the highest priority, among the logical channels that satisfy all the following conditions: the logical channel with SL data available for transmission; and the CAPC value of the logical channel belonging to list-x of destination is equal to or smaller than the CAPC value-x; or the CAPC value of the logical channel belonging to list-y of destination is equal to or smaller than the CAPC value-y.

The first UE may select the MAC CE or logical channels satisfying all the following conditions among the logical channels belonging to the selected Destination: SL data is available for transmission; and the CAPC value is equal to or smaller than the CAPC value associated to the selected Destination.

### Implementation Example 3-3: UE Acquires M (M>1) Grants Which are Corresponding to the Same COT

If a UE acquires M (M>1) grants which are corresponding to the same COT, there can be several solutions.

Solution 1: If the grant is the first one of the M grants, the UE can perform sidelink Logical Channel Prioritization procedure as the implementation example 3-1.

If the grant is not the first one of the M grants, the UE has selected the destination corresponding to the COT for the previous grant within the M grants, the UE may select a Destination having at least one of the MAC CE and the logical channel with the highest priority, then select the MAC CE or logical channels satisfying all the following conditions among the logical channels belonging to the selected Destination: SL data is available for transmission; and the CAPC value is equal to or smaller than the CAPC value associated to the selected Destination.

If the grant is not the first one of the M grants, and the UE has selected the destination corresponding to the COT and no LBT failure indication is received for the previous grant within the M grants, the UE may select a Destination having at least one of the MAC CE and the logical channel with the highest priority, then select the MAC CE or logical channels satisfying all the following conditions among the logical channels belonging to the selected Destination: SL data is available for transmission; and the CAPC value is equal to or smaller than the CAPC value associated to the selected Destination.

Solution 2: If the grant is not the last one of the M grants, the UE may select a Destination having at least one of the MAC CE and the logical channel with the highest priority, then select the MAC CE or logical channels satisfying all the following conditions among the logical channels belonging to the selected Destination: SL data is available for transmission; and the CAPC value is equal to or smaller than the CAPC value associated to the selected Destination.

If the grant is the last one of the M grants, and the UE has selected the destination corresponding to the COT for the previous grant within the M grants, or the UE has selected the destination corresponding to the COT and no LBT failure indication is received for the previous grant within the M grants, the UE may select a Destination having at least one of the MAC CE and the logical channel with the highest priority, then select the MAC CE or logical channels satisfying all the following conditions among the logical channels belonging to the selected Destination: SL data is available for transmission; and the CAPC value is equal to or smaller than the CAPC value associated to the selected Destination.

If the grant is the last one of the M grants, and the UE has not selected the destination corresponding to the COT for the previous grant within the M grants, or the UE has selected the destination corresponding to the COT and LBT failure indication is received for the previous grant within the M grants, the UE can perform sidelink Logical Channel Prioritization procedure as implementation example 3-1.

### Implementation Example 4: Consistent LBT Failure

In SL-U, an SL-specific LBT failure indication counter (e.g. SL_LBT_COUNTER) can be introduced for the SL-specific consistent LBT failure detection. If an SL-specific LBT failure indication is received from the lower layer, the SL-specific LBT failure indication counter (e.g. SL_LBT_COUNTER) can be incremented by one. If the SL-specific LBT failure indication counter value is equal to or larger than the SL-specific maximum LBT failure instance count threshold (e.g. sl-LBT-FailureInstanceMaxCount), consistent LBT failure can be triggered/declared by the MAC entity.

If a UE can perform sidelink in multiple RB set, the UE may maintain multiple SL-specific LBT failure indication counter for each RB set. If a physical sidelink share channel (PSSCH) is corresponding to multiple PSFCH such as N PSFCH, for example, when a LBT failure is detected for any one of N PSFCH, the SL-specific LBT failure indication counter for this RB SET may plus one. For another example, when LBT failure is detected for all of N PSFCH, the SL-specific LBT failure indication counter for this RB SET may plus one.

It should be understood that one or more features from the above implementation examples are not exclusive to the specific implementation examples, but can be combined in any manner (e.g., in any priority and/or order, concurrently or otherwise).

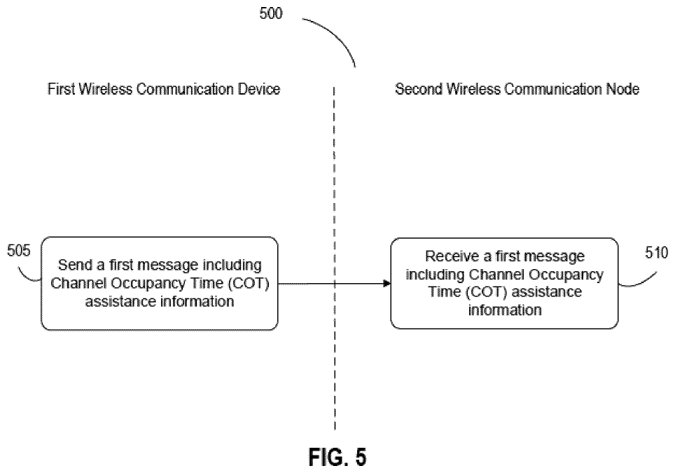

FIG. 5 illustrates a flow diagram of a method 500 for performing sidelink Channel Occupancy Time (COT) sharing on an unlicensed carrier/shared spectrum. The method 500 may be implemented using any one or more of the components and devices detailed herein in conjunction with FIGS. 1-2. In overview, the method 500 may be performed by a wireless communication device (e.g., a UE), in some embodiments. Additional, fewer, or different operations may be performed in the method 500 depending on the embodiment. At least one aspect of the operations is directed to a system, method, apparatus, or a computer-readable medium.

A first wireless communication device (e.g., a responding UE) may send a first message including Channel Occupancy Time (COT) assistance information to a second wireless communication device (e.g., a initiating UE). The second wireless communication device can initiate sharing of a COT with the first wireless communication device. The COT assistance information may comprise one or more sets of parameters for each of a plurality of Channel Access Priority Class (CAPC) values, each of the sets of parameters associated with one or more logical channels. Each of the sets of parameters may comprise at least one of the following information: trafficPeriodicity, Duration, RBNum, SubbandNum, MintimingOffset, MaxtimingOffset, or Buffer size information. When one of the CAPC values is associated with multiple logical channels, the COT assistance information may include multiple sets of the parameters for the CAPC value. When one of the CAPC values is associated with multiple logical channels, the Buffer size information or a size of data estimated arrival may correspond to a sum of all the associated logical channels.

In some embodiments, the COT assistance information may only include parameters for one or more logical channels associated with respective dedicated destination ID(s). The COT assistance information may include a buffer size field and a CAPC value field, the buffer size field being configured to indicate a total amount of data available across all logical channels associated with a CAPC value, the CAPC value field being configured to indicate a CAPC value of one or more logical channels with a reported sidelink buffer status.

In some embodiments, the first wireless communication device may determine that at least one of the following conditions is met so as to send the COT assistance information: (1) content of the COT assistance information has changed; (2) sidelink data for a logical channel has become available, and the sidelink data belongs to a logical channel with a higher priority than a priority of any other logical channel containing available sidelink data; (3) sidelink data for a logical channel associated with a higher priority CAPC value has become available; (4) sidelink data for a logical channel associated with a lower priority CAPC value has become available; (5) an LBT failure has been detected; (6) a timer has been expired; (7) the first wireless communication device has received a second message from the second wireless communication device, indicating that the second wireless communication device can provide the COT; or (8) LBT failure has been detected for X times. A value of timer or a number of X can be configured by the network, or preconfigured. The timer can be started or restarted upon the COT assistance information is sent.

In some embodiments, the first wireless communication device may receive, from the second wireless communication device, a second message indicating the sharing of the COT, before sending the COT assistance information. The second message may further indicate one or more destination IDs. The COT assistance information may include multiple sets of parameters, with their respective values sequentially indexed in a same order presented in the second message. The first wireless communication device can be selected by the second wireless communication device for the sharing of the COT, when at least one of the following conditions is met: (1) an indicated CAPC value in the COT assistance information is equal to or smaller than a CAPC value associated with a COT resource and a lowest CAPC value; (2)an indicated CAPC value in the COT assistant information is equal to or smaller than a CAPC value associated with a COT resource and a highest CAPC value; or (3) a size of data estimated arrival or in buffer in the COT assistant information is largest, wherein a CAPC value of the data is equal to or smaller than a CAPC value associated with a COT resource.

In some embodiments, in response to acquiring a first sidelink grant, initiating, by a first wireless communication device (e.g., a responding UE), a Logical Channel Prioritization (LCP) procedure for performing a sidelink transmission, wherein the LCP procedure further comprises: selecting, by the first wireless communication device, one from a plurality of destinations on a list; and selecting, by the first wireless communication device, one or more from a plurality of logical channels belonging to the selected destination. The first sidelink grant can be associated with one or more Channel Occupancy Times (COTs) shared by one or more second wireless communication devices with the first wireless communication device. The COT can be received from multiple different UEs. The shared resource in different COTs have overlapping. For some grants (e.g., in overlapping part), the shared resource may correspond to multiple COTs.

In some embodiments, the first wireless communication device may identify that the first sidelink grant is associated with a single COT that corresponds to a designated destination ID and a designated CAPC value. The first wireless communication device may select the destination, with the designated destination ID, that has sidelink data available for transmission and a CAPC value equal to or smaller than the designated CAPC value. The first wireless communication device may select the logical channel having sidelink data available for transmission and a CAPC value equal to or smaller than the designated CAPC value.

In some embodiments, the first wireless communication device may identify that the first sidelink grant is associated at least with a first COT that corresponds to a first designated destination ID and a first designated CAPC value, and a second COT that corresponds to a second designated destination ID and a second designated CAPC value. The first wireless communication device may select the destination, with the first or second designated destination ID, that has sidelink data available for transmission and a CAPC value equal to or smaller than the first or second designated CAPC value. The first wireless communication device may select the logical channel having sidelink data available for transmission and a CAPC value equal to or smaller than the first or second designated CAPC value.

In some embodiments, the first wireless communication device may identify that the first sidelink grant is associated at least with a first COT that corresponds to a first designated destination list and a first designated CAPC value, and a second COT that corresponds to a second designated destination list and a second designated CAPC value. The first wireless communication device may select the destination, on the first or second designated destination list, that has sidelink data available for transmission and a CAPC value equal to or smaller than the first or second designated CAPC value, in which a logical channel of the selected destination has a highest priority. The first wireless communication device may select the logical channel having sidelink data available for transmission and a CAPC value equal to or smaller than the first or second designated CAPC value.

In some embodiments, the first wireless communication device may receive a message indicating sharing of the one or more COTs from the second wireless communication device. If no destination is selected in any of above embodiments, the first wireless communication device may select the destination having at least one of its MAC CE or a logical channel with a highest priority.

In some embodiments, the first wireless communication device may determine that a type 1 Listen-Before-Talk (LBT) procedure for the grant will fail. If no destination is selected in any of above embodiments, the first wireless communication device may select no destination. In some embodiments, the first wireless communication device may determine that a type 1 LBT procedure for the grant will succeed. If no destination is selected in any of above embodiments, the first wireless communication device may select the destination having at least one of its MAC CE or a logical channel with a highest priority.

In some embodiments, the first wireless communication device may identify that a size of a remaining portion of the first sidelink grant is equal to or smaller than N bytes. The first wireless communication device may transmit a padding.

In some embodiments, the first wireless communication device may identify that a size of a remaining portion of the first sidelink grant is equal to or larger than N bytes and determine a type 1 LBT procedure for the grant will fail. The first wireless communication device may transmit a padding.

In some embodiments, the first wireless communication device may identify that a size of a remaining portion of the first sidelink grant is equal to or larger than N bytes. The first wireless communication device may select the logical channel regardless of a CAPC value.

In some embodiments, the first wireless communication device may identify that a size of a remaining portion of the first sidelink grant is equal to or larger than N bytes to determine a type 1 LBT procedure for the grant will succeed. The first wireless communication device may select the logical channel regardless of a CAPC value.

In some embodiments, the first wireless communication device may acquire M (more than one) sidelink grants that correspond to the same COT that corresponds to a designated destination ID list and a designated CAPC value. In response to determining that the first sidelink grant is a first one of the M sidelink grants, the first wireless communication device may select the destination, from the designated destination ID list, that has sidelink data available for transmission and a CAPC value equal to or smaller than the designated CAPC value; the first wireless communication device may select the logical channel having sidelink data available for transmission and a CAPC value equal to or smaller than the designated CAPC value.

In some embodiments, the first wireless communication device may acquire M (more than one) sidelink grants that correspond to the same COT that corresponds to a designated destination ID list (e.g., one or mode destination IDs) and a designated CAPC values. The first wireless communication device may determine that the first sidelink grant is not a first one of the M sidelink grants, and a destination from the designated destination ID list has been selected for a previous one of the M sidelink grants. The first wireless communication device may select the destination having at least one of its MAC CE or a logical channel with a highest priority.

In some embodiments, the first wireless communication device may acquire M (more than one) sidelink grants that correspond to the same COT that corresponds to a designated destination ID list and a designated CAPC value. The first wireless communication device may determine that the first sidelink grant is not the first one of the M sidelink grants, and a destination from the designated destination ID list has been selected, and no indication of a LBT failure has been received for a previous one of the M sidelink grants. The first wireless communication device may select the destination having at least one of its MAC CE or a logical channel with a highest priority.

In some embodiments, the first wireless communication device may acquire M (more than one) sidelink grants that correspond to the same COT that corresponds to a designated destination ID list and a designated CAPC value. The first wireless communication device may determine that the first sidelink grant is not the first one of the M sidelink grants, and a destination from the designated destination ID list has not been selected for a previous one of the M sidelink grants. The first wireless communication device may select the destination, from the designated destination ID list, that has sidelink data available for transmission and a CAPC value equal to or smaller than the designated CAPC value. The first wireless communication device may select the logical channel having sidelink data available for transmission and a CAPC value equal to or smaller than the designated CAPC value.

In some embodiments, the first wireless communication device may acquire M (more than one) sidelink grants that correspond to the same COT that corresponds to a designated destination ID list and a designated CAPC values. The first wireless communication device may determine that the first sidelink grant is the last one of the M sidelink grants and a destination from the designated destination ID list has been selected for a previous one of the M sidelink grants. The first wireless communication device may select the destination having at least one of its MAC CE or a logical channel with a highest priority.

In some embodiments, the first wireless communication device may acquire M (more than one) sidelink grants that correspond to the same COT that corresponds to a designated destination ID list and a designated CAPC value. The first wireless communication device may determine that the first sidelink grant is the last one of the M sidelink grants, and a destination from the designated destination ID list has not been selected for a previous one of the M sidelink grants. The first wireless communication device may select the destination, from the designated destination ID list, that has sidelink data available for transmission and a CAPC value equal to or smaller than the designated CAPC value. The first wireless communication device may select the logical channel having sidelink data available for transmission and a CAPC value equal to or smaller than a designated CAPC value.

In some embodiments, the first wireless communication device may acquire M (more than one) sidelink grants that correspond to the same COT that corresponds to a designated destination ID list and a designated CAPC value. The first wireless communication device may determine that the first sidelink grant is the last one of the M sidelink grants and a destination from the designated destination ID list has been selected and no indication of a LBT failure has been received for a previous one of the M sidelink grants. The first wireless communication device may select the destination having at least one of its MAC CE or a logical channel with a highest priority.

In some embodiments, the first wireless communication device may acquire M (more than one) sidelink grants that correspond to the same COT that corresponds to a designated destination ID list and a designated CAPC value. The first wireless communication device may determine that the first sidelink grant is not the last one of the M sidelink grants. The first wireless communication device may select the destination having at least one of its MAC CE or a logical channel with a highest priority.

In some embodiments, a second wireless communication device may receive a first message including first Channel Occupancy Time (COT) assistance information from a first wireless communication device. The second wireless communication device can initiate sharing of a COT with the first wireless communication device. The second wireless communication device may receive a third message including second COT assistance information from a third wireless communication device. The second wireless communication device may select the first wireless communication device for the sharing of the COT, when at least of the following conditions is met: (1) an indicated CAPC value in the first COT assistance information is equal to or smaller than a CAPC value associated with a COT resource and a lowest CAPC value; (2) an indicated CAPC value in the first COT assistant information is equal to or smaller than a CAPC value associated with a COT resource and a highest CAPC value; or (3) a size of data estimated arrival or in buffer in the first COT assistant information is largest, wherein a CAPC value of the data is equal to or smaller than a CAPC value associated with a COT resource.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A wireless communication method, comprising:
in response to acquiring a first sidelink grant, initiating, by a first wireless communication device, a Logical Channel Prioritization (LCP) procedure for performing a sidelink transmission, wherein the LCP procedure further comprises:
selecting, by the first wireless communication device, one from a plurality of destinations on a list; and
selecting, by the first wireless communication device, one or more from a plurality of logical channels belonging to the selected destination,
wherein the first sidelink grant is associated with one or more Channel Occupancy Times (COTs) shared by one or more second wireless communication devices with the first wireless communication device.

2. The wireless communication method of claim 1, further comprising:
identifying, by the first wireless communication device, that the first sidelink grant is associated with a single COT that corresponds to a designated destination ID and a designated CAPC value;
selecting, by the first wireless communication device, the destination, with the designated destination ID, that has sidelink data available for transmission and a CAPC value equal to or smaller than the designated CAPC value; and
selecting, by the first wireless communication device, the logical channel having sidelink data available for transmission and a CAPC value equal to or smaller than the designated CAPC value.

3. The wireless communication method of claim 1, further comprising:
receiving, by the first wireless communication device from the second wireless communication device, a message indicating sharing of the one or more COTs.

4. The wireless communication method of claim 2, further comprising:
selecting, by the first wireless communication device, the destination having at least one of its MAC CE or a logical channel with a highest priority.

5. A first wireless communication device, comprising:
at least one processor configured to:
in response to acquiring a first sidelink grant, initiate a Logical Channel Prioritization (LCP) procedure for performing a sidelink transmission, wherein the at least one processor configured to perform the LCP procedure by:
selecting one from a plurality of destinations on a list; and
selecting one or more from a plurality of logical channels belonging to the selected destination,
wherein the first sidelink grant is associated with one or more Channel Occupancy Times (COTs) shared by one or more second wireless communication devices with the first wireless communication device.

6. The first wireless communication device of claim 5, further comprising:
identifying, by the first wireless communication device, that the first sidelink grant is associated with a single COT that corresponds to a designated destination ID and a designated CAPC value;
selecting, by the first wireless communication device, the destination, with the designated destination ID, that has sidelink data available for transmission and a CAPC value equal to or smaller than the designated CAPC value; and
selecting, by the first wireless communication device, the logical channel having sidelink data available for transmission and a CAPC value equal to or smaller than the designated CAPC value.

7. The first wireless communication device of claim 5, further comprising:
receiving, by the first wireless communication device from the second wireless communication device, a message indicating sharing of the one or more COTs.

8. The first wireless communication device of claim 6, further comprising:
selecting, by the first wireless communication device, the destination having at least one of its MAC CE or a logical channel with a highest priority.

9. A non-transitory computer readable medium, storing code, which when executed by at least one processor, causes the at least one processor to:
in response to acquiring a first sidelink grant, initiate a Logical Channel Prioritization (LCP) procedure for performing a sidelink transmission, wherein the at least one processor configured to perform the LCP procedure by:
selecting one from a plurality of destinations on a list; and
selecting one or more from a plurality of logical channels belonging to the selected destination,
wherein the first sidelink grant is associated with one or more Channel Occupancy Times (COTs) shared by one or more second wireless communication devices with the first wireless communication device.

10. The non-transitory computer readable medium of claim 9, wherein the code, when executed by the at least one processor, causes the at least one processor to:
identify that the first sidelink grant is associated with a single COT that corresponds to a designated destination ID and a designated CAPC value;
select the destination, with the designated destination ID, that has sidelink data available for transmission and a CAPC value equal to or smaller than the designated CAPC value; and
select the logical channel having sidelink data available for transmission and a CAPC value equal to or smaller than the designated CAPC value.

11. The non-transitory computer readable medium of claim 9, wherein the code, when executed by the at least one processor, causes the at least one processor to:
receive, via a receiver from the second wireless communication device, a message indicating sharing of the one or more COTs.

12. The non-transitory computer readable medium of claim 10, wherein the code, when executed by the at least one processor, causes the at least one processor to:
select the destination having at least one of its MAC CE or a logical channel with a highest priority.
